(19) United States
(12) Patent Application Publication
(10) Pub. No.: US 2018/0137409 A1
(43) Pub. Date: May 17, 2018

(54) METHOD OF CONSTRUCTING AN ARTIFICAL INTELLIGENCE SUPER DEEP LAYER LEARNING MODEL, DEVICE, MOBILE TERMINAL, AND SOFTWARE PROGRAM OF THE SAME

(71) Applicant: ZECANG GU, Yokohama (JP)

(72) Inventor: ZECANG GU, Yokohama (JP)

(21) Appl. No.: 15/810,105

(22) Filed: Nov. 12, 2017

(30) Foreign Application Priority Data
Nov. 14, 2016 (CN) 201611034133.6

(51) Int. Cl. G06N 3/04; G06N 3/08; G06N 5/04

(52) U.S. Cl. CPC G06N 3/0436; G06N 5/048; G06N 3/088; G06N 3/0481

(57) ABSTRACT

A method for constructing an artificial intelligence super depth learning model includes inputting by an objective function to input into each node of an input layer by interposing a no-teacher machine learning, connecting the no-teacher machine learning mutually between each node of the input layer and a nerve layer, calculating output reference values based on a learning value obtained by the no-teacher machine learning, a trigger threshold of a cranial nerve, or a sampling learning value, and determining an excitation level according to output reference values of all the nerve layers.

### CROSS-REFERENCE TO RELATED APPLICATIONS

This application claims all benefits accruing under 35 U.S.C. § 119 from China Patent Application No. 201611034133.6, filed on Nov. 14, 2016 in the State Intellectual Property Office of China, the content of which is hereby incorporated by reference.

### FIELD

The present disclosure relates to an intelligent super deep learning model belonging to the field of information processing, in particular, a method for constructing an artificial intelligence super deep layer learning model, a method for constructing an artificial intelligence super deep layer learning device, and a general purpose mobile terminal device equipped with an artificial intelligence super deep layer learning model

### BACKGROUND

In recent years, artificial intelligence has become a hot topic in the world range, and the related patents of artificial intelligence are drawing attention. Using an artificial intelligent neural network algorithm to extract threshold edge image, it is possible to obtain highly accurate edge images.

A control method for vehicles to select driving status automatically, in order to avoid the occurrence of a traffic accident can be applied to the automatic driving field. Even if the driver is not reflected, the control method can automatically prevent the occurrence of a traffic accident to avoid unforeseen circumstances through the artificial intelligence of the machine learning algorithm of the reverse transfer neural network.

In order to choose a weight value W and a threshold value T of a conventional neural network, all the possibilities need to be combined to obtain the optimal solution. The total number of the combinations is P×(W×T)ⁿ, where P is the number of layers of the conventional neural network and n is the number of the node of each layer.

Computational complexity becomes O (nⁿ) due to the enormous number of combinations, and it becomes a problem of NP-hard as shown in the above equation. Therefore, it is impossible to obtain the result of calculation using the current calculator.

Furthermore, since the weight value W of the conventional neural network model and the method of defining the threshold value T use only conventional mathematics, they are completely different from the principle of the brain trigger signal as a result. The nerve of the human brain revealed a totally different mechanism from the conventional neural network model.

Also, since the actual objective function originally belonged to the probability problem, the conventional neural network model can only have a map function, hence it is necessary to rely on mass learning data. Since it is difficult to solve the probability problem, particularly at the time of choosing the weight value W and the threshold value T, an optimal solution is not obtained, thus leaving a black box problem.

Although in the deep learning model, which is currently drawing attention, the processing ability increases deeply by increasing the number of hidden layers by more than several hundred on the basis of the conventional neural network model, it cannot theoretically prove that there is a relationship between the number of hidden layers and the processing ability. Therefore, the complexity of calculation must be further increased by such a configuration. The deep learning model cannot be expected to apply widely in industry.

### SUMMARY

An aspect of the present disclosure includes a neural network model that can reproduce the function of the brain with emphasis on the function of the human brain trigger, and with unchanged calculation complexity. When human cranial nerves are triggered by nerves, a method to accurately construct a new neural network model capable of matching the role of the neural threshold is desired. In addition, the ability of machine learning can go infinitely deep.

Another aspect of the present disclosure includes an artificial intelligence model, which is fundamentally more advanced than the conventional deep learning model, with low calculation complexity and high efficiency for application to actual industrialization.

### BRIEF DESCRIPTION OF THE DRAWINGS

FIG. 1 is a block diagram of an artificial intelligence super deep layer learning model.

FIG. 2 is a schematic diagram of an actual artificial intelligence super depth machine learning model.

FIG. 3 is a configuration diagram of a model of super deep learning for speech recognition.

FIG. 4 is a schematic diagram of a model structure of super deep layer learning for speech recognition.

FIG. 5 is a processing flow diagram of self-organization based on the probability scale.

FIG. 6 is a schematic diagram of a stock forecasting platform introducing super depth learning.

### DETAILED DESCRIPTION

A detailed description with the above drawing is made to further illustrate the present disclosure. As described below, embodiments of the present disclosure will be described in more detail with reference to the accompanying drawings, but embodiments of the present disclosure are illustrative and not limiting.

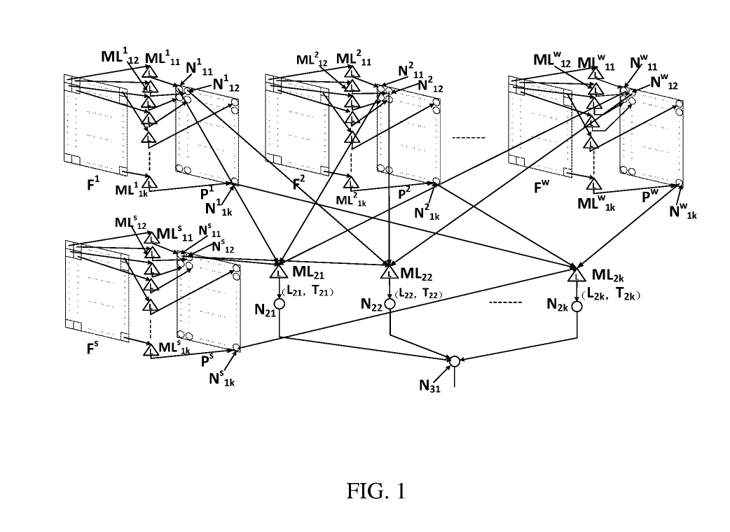

FIG. 1 is a block diagram of an artificial intelligence super deep layer learning model. As shown in FIG. 1, the number of nodes of the hidden layer, that is, the nerve layer is defined as h (h=1, 2, . . . , K), the number of times of learning is z (z=1, 2, . . . , w), and the learned image is F^{z} (z=1, 2, . . . , w).

When doing the first learning, input information is learned by non-teacher machine learning and then input to the node of the input layer. Then, for the input layer p=1 for the no-teacher machine learning, ML^{z}ₚₕ, ML^{z}₁ₕ, and then,

$${ML}_{11}^{1} , {ML}_{12}^{1} , … , {ML}_{1 k}^{1} \\ {ML}_{11}^{2} , {ML}_{12}^{2} , … , {ML}_{1 k}^{2} \\ … , \\ {ML}_{11}^{w} , {ML}_{12}^{w} , … , {ML}_{1 k}^{w} \qquad ( Equation 1 )$$

Therefore, since the complexity of computing learned by each training of no-teacher machines in the learning stage is linear, the complexity of computation to be learned w times is O (n²).

Here, the objective function is to recognize of the image and the objective function information is image information, the node N^{z}ₚₕ of each layer is defined. When the input layer p=1, let the input layer node be N^{z}₁ₕ.

$${N}_{11}^{1} , {N}_{12}^{1} , … , {N}_{1 k}^{1} \\ {N}_{11}^{2} , {N}_{12}^{2} , … , {N}_{1 k}^{2} \\ … , \\ {N}_{11}^{w} , {N}_{12}^{w} , … , {N}_{1 k}^{w} \qquad ( Equation 7 )$$

Likewise, when performing the second learning, it is also necessary to learn by connecting the no-teacher machine learning between the node of the input layer and the hidden layer. That is, the node of the neural layer, where P=2, and non-teacher machine learning is defined M^{L}₂ₕ.

ML₂₁,ML₂₂, . . . ,ML₂ₖ (Equation 3)

Likewise, p=2 for the nodes of the hidden layer, that is, the nerve layer, and the hidden layer, that is, the node of the nerve layer is N₂ₕ.

N₂₁,N₂₂, . . . ,N₂ₖ (Equation 4)

Similarly, since the output layer, that is, the cerebral cortex p=3, which has only one node, the node of the output layer (cerebral cortex) is N₃₁.

Next, for the identification step, since the input layer p=1 for the ML^{s}ₚₕ, the no-teacher machine learning which needs to extract the feature information of the image Fs to be identified is set to ML^{s}₁ₕ.

ML^{s}₁₁,ML^{s}₁₂, . . . ,ML^{s}₁ₖ (Equation 5)

Likewise, since only one piece of feature information of the image Fs to be identified corresponds to the node of the input layer, the node of the input layer is N^{s}₁ₕ.

N^{s}₁₁,N^{s}₁₂, . . . ,N^{s}₁ₖ (Equation 6)

In the case of performing the identification step, the learned data is directly input to the information of the image Fs by the no-teacher machine learning ML^{s}₁ₕ directly between the input layer and the hidden layer, that is, the nerve layer by the no-teacher machine learning ML₂ₕ.

Here, as shown in FIG. 1, as an example of the image recognition method in the learning step, it is assumed that F is an image to be learned, and the target image F is divided into one image of n*m pixels. Here, the k number of h^{th} divided images are set as I^{h}ϵp^{h}ᵢⱼ (i=1, 2, . . . , n, j=1, 2, . . . , m, h=1, 2, . . . , k), and pixels belonging to the divided image are p^{h}ᵢⱼ, each pixel p^{h}ᵢⱼ of one divided image I^{h}ϵp^{h}ᵢⱼ is inputted to the input side of one non-teacher machine learning ML^{z}₁ₕ, and one pixel from each pixel of the divided image I^{h}ϵp^{h}ᵢⱼ. The feature value of the maximum probability was extracted by learning of non-teacher machine learning. By repeating such processing, it becomes possible to extract the feature vector of the maximum probability of the target image F from all the divided images I^{h}ϵp^{h}ᵢⱼ of the target image F.

Based on the above processing method, when the gray value of g pieces of pixels p^{h}ᵢⱼ of the h (h=1, 2, . . . , K)^{th} image I^{h}ϵp^{h}ᵢⱼ of the z^{th} (z=1, 2, . . . , w) image F^{z} (z=1, 2, . . . , w) is inputted to the first non-teacher machine learning ML¹₁ₕ, the obtained learning result L¹₁ₕ is sent to the h^{th} node N¹₁ₕ of the first input layer. And the result of learning by k×z pieces of non-teacher machine learning against the learned z^{th} image F^{z} is inputted to k pieces of nodes of the first input layer. The learned image F^{z} obtained under w pieces of different generation circumstance is data L^{z}₁ₕ of the w×k pieces of input layer by the non-teacher machine learning, that is

$${L}_{11}^{1} , {L}_{12}^{1} , … , {L}_{1 k}^{1} \\ {L}_{11}^{2} , {L}_{12}^{2} , … , {L}_{1 k}^{2} \\ … , \\ {L}_{11}^{w} , {L}_{12}^{w} , … , {L}_{1 k}^{w} \qquad ( Equation 7 )$$

When learning the feature values L^{z}₁₁, L^{z}₁₂, . . . , L^{z}₁ₖ, (z=1, 2, . . . , w) corresponding to each node N^{z}₁ₕ of the z^{th} input layer with the second unmatched machine learning ML₂ₕ, learning values L₂₁, L₂₂, . . . , L₂ₖ were obtained. In addition, each maximum probability measure or the maximum fuzzy event probability measure was also obtained. All of the above results with the maximum probability scale or the maximum fuzzy event probability measure as the cranial nerve trigger threshold T₂ₕ (h=1, 2, . . . , k) are registered as a database.

In the recognition step, when g pixels in the h (h=1, 2, . . . , K) region of the recognized image F^{s} are input to the no-teacher machine learning ML^{S}₁ₕ, the learning value L^{S}₁ₕ of the learned sampling is transmitted to k pieces of the node N^{S}₂ₕ (h=1, 2, . . . , k). By using the learning value L^{S}₁ₕ of the sampling of the recognized image F^{S}, the learning value L₂ₕ value registered in the database, and the threshold value T₂ₕ of the cranial nerve trigger,

|L^{S}₁ₕ−L₂ₕ|≤T₂ₕ→“1” (h=1,2, . . . ,k) (Equation 8)

The h (h=1, 2, . . . , k)^{th} node N₂ₕ of the hidden layer, that is, the nerve layer is triggered, and in other cases, no signal is outputted.

|L^{S}₁ₕ−L₂ₕ|>T₂ₕ→“0” (h=1,2, . . . ,k) (Equation 9)

Its output layer, that is, the cerebral cortex, determines the degree of excitation of the brain by the number of neural signals triggered from the hidden layer, that is, the nerve layer. By determining the degree to which the image F^{s} to be recognized belongs to the learned image depending on the extent of excitement of the neurons, i.e., the number of outputs “1” of each node of the hidden layer, that is, the neural layer, the effect of decision making can be fulfilled.

Further, at the time of identification, by calculating the probability that the output of each node of the hidden layer, that is, the nerve layer is “1” based on the results of plural identifications for recognizing the identification image and also by self-correcting the identification parameter, it is possible to fulfill the self-learning effect.

Here, there are two methods of algorithm for correcting the identification parameter. One way is that when the probability of the output “1” of each node of the hidden layer, that is, the nerve layer is calculated, the output reference value of each node of the hidden layer, that is, the nerve layer, is multiplied by the probability value of that node. When the probability that each node of the hidden layer, that is, the nerve layer, outputs “1” is defined as Pₕ (h=1, 2, . . . , k), and the output reference value after correction of each node of the hidden layer, that is, the nerve layer is defined as NVₕ (h=1, 2, . . . , k), the excitation value XV of the output layer belonging to the image corresponding to the learning value L₂ₕ, that is, the excitation value XV of the cerebral cortex is defined as

$$XV = {\sum }_{h = 1}^{k} {NV}_{h} * {P}_{h} \qquad ( Equation 10 )$$

The other method is to re-input the identified image into the hidden layer, that is, the neural layer as learning data and to re-learn to obtain a new learning result. Statistical algorithms may be used when it is not a method of learning between nodes connected by non-teacher machine learning as described above. For example, it is within the scope of the present invention to construct a super depth machine learning model similar to the above by various statistical calculations such as average value and variance value and by other machine learning.

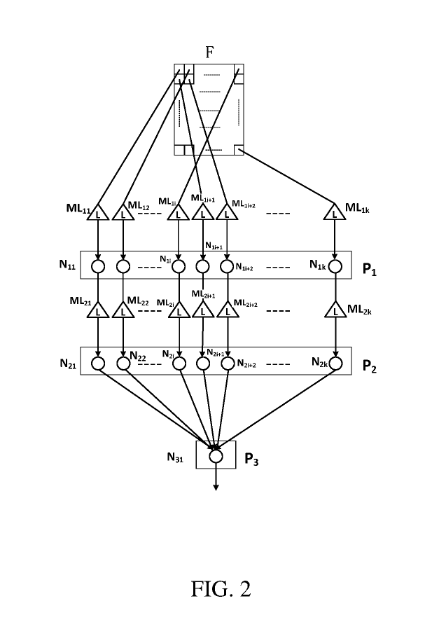

FIG. 2 is a schematic diagram of an actual artificial intelligence super depth machine learning model. At the time of learning the image, F set of images is obtained by reading w times of the images. As the result of w times learning by using k pieces of non-teacher machine learning of ML₁ₕ (h=1, 2, . . . , k) for FϵF^{z} (z=1, 2, . . . , w) images, L¹₁ₕ, L²₁ₕ, . . . , L^{z}₁ₕ (z=1, 2, . . . , k) are sent to each node N₁ₕ (h=1, 2, . . . , k) of the input layer P1. Furthermore, the w times learning results of the input layer are sent to the no-teacher machine learning ML₂ₕ (h=1, 2, . . . , k). The threshold values (L₂ₕ, T₂ₕ) (h=1, 2, . . . , k) of learning values and cranial nerve triggers are generated using the non-teacher machine learning ML₂ₕ (h=1, 2, . . . , k).

As shown in FIG. 2, in the learning step, F^{z} (z=1, 2, . . . , W) images are respectively w times inputted into k pieces of non-teacher machine learning ML₁ₕ (h=1, 2, . . . , k), and the learning data L^{z}₁ₕ (h=1, 2, . . . , K, z=1, 2, . . . , w) are obtained. The results L₁ₕ (h=1, 2, . . . , k) learned by w times are sent to each node N₁ₕ (h=1, 2, . . . , k) of the input layer.

The w pieces of data L₁ₕ (h=1, 2, . . . , K) obtained by the h nodes N₁ₕ of the input layer are further learned by the non-teacher machine learning ML₂ₕ (h=1, 2, . . . , k). As a result, k pieces of new neural network learning values and cranial nerve trigger threshold (L₂ₕ, T₂ₕ) (h=1, 2, . . . , K) are obtained. In the recognition step, similarly to the above, by inputting the recognized image F^{s} to the k pieces of non-teacher machine learning of ML₁ₕ (h=1, 2, . . . , K) and learning, the learning values L^{s}₁ₕ (H=1, 2, . . . , k) are obtained. Likewise, each node N₁ₕ (h=1, 2, . . . , K) of the input layer P1 is sent. The output reference value of the hidden layer, that is, the nerve layer, calculates the output reference value through the non-teacher machine learning ML₂ₕ (h=1, 2, . . . , k) connected between the input layer and the hidden layer, that is, the nerve layer. |L^{S}₁ₕ−L₂ₕ|≤T₂ₕ→‘1’ which means the hidden layer, that is, the nerve layer outputs ‘1’, otherwise it is |L^{S}₁ₕ−L₂ₕ|>T₂ₕ→‘0’ which means that there is no neural signal.

The output layer, that is, the cerebral cortex, determines the level of excitation of the brain based on the number of ‘1’s' output by the hidden layer, that is, the nerve layer, as described above. Depending on the degree of neural excitation, the image to be identified belongs to the F image learned based on the number of “1” output by the hidden layer, that is, the nerve layer. This is an effect of cranial nerve decision making. In addition, since the processing capability and the processing accuracy are high, the above-described super depth machine learning firstly divides the image I^{h} ϵp^{h}ᵢⱼ (i=1, 2, . . . , n, j=1, 2, . . . , m, h=1, 2, . . . , k). The more the number of divided images, the higher the accuracy of image recognition. Or, when mapping an image to the target image F from the original image, using a geometric model or a physical model, the number of mappings of the image is increased. The more the number of images mapped, the higher the accuracy of image recognition likewise. With these two approaches, the computational complexity does not change by increasing the number of nodes of the input layer and the hidden layer, that is, the neural layer, and the number of machine learning. As described above, the super deep learning model of the present invention can theoretically prove that the throughput and accuracy become infinitely deep.

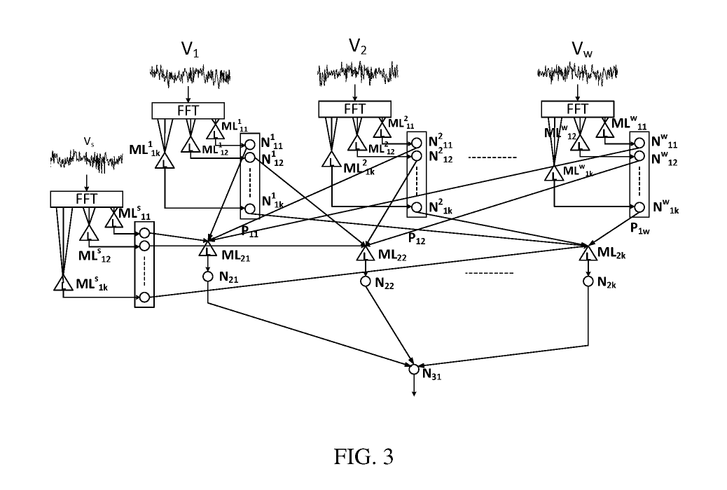

FIG. 3 is a configuration diagram of a model of super deep learning for speech recognition. Here, the objective function is voice recognition, and the objective function information is voice information. As shown in FIG. 3, in the learning step, z (z=1, 2, . . . , w) pieces of speech signals can be converted to the spectrum data by fast Fourier transform FFT on each speech signal V_{z} (z=1, 2, . . . , w). By assuming the value of each adjacent x spectrum as one feature value of h=y/x, the feature value of h (h=1, 2, . . . , K) pieces of input layers are obtained. Also, by inputting each x number of spectra to each of the no-teacher machine learning ML^{z}₁₁, L^{z}₁ₕ (h=1, 2, . . . , k, z=1, 2, w) feature values are obtained. After that, it sends to each node N^{z}₁ₕ (h=1, 2, . . . , k, z=1, 2, . . . , w) of the input layer.

The feature value L^{z}₁₁ (z=1, 2, . . . , w) of the first node N^{z}₁₁ of the w pieces of input layer calculated by the no-teacher machine learning ML^{z}₁₁ is sent to the input side of the teacher machine learning ML₂₁ connected between the input layer and the hidden layer, that is, the nerve layer. Likewise, the feature value L^{z}₁₂ (z=1, 2, . . . , w) of the second node N^{z}₁₂ of the w pieces of input layer calculated by ML^{z}₁₂ is sent to the input side of the ML₂₂ so that the feature value L^{z}₁ₖ (z=1, 2, . . . , W) of the k^{th} node N^{z}₁ₖ of the w pieces of input layers calculated by the ML^{z}₁ₖ is sent to the input side of ML₂ₖ. Then, k pieces of learning values L₂ₕ and k threshold values T₂ₕ of triggers of cranial nerves, that is, (L₂ₕ, T₂ₕ) (h=1, 2, . . . , k) are calculated by k pieces of non-teacher machine learning ML₂ₖ connected between the input layer and the hidden layer, that is, the nerve layer. The result is stored in a database.

In the recognition step, the voice Vₛ to be identified is converted from the spectrum data of the voice signal of Vₛ by the fast Fourier transform FFT in the same manner as in the learning state described above. Information of h=y/x, h (h=1, 2, . . . , k) pieces of input layers is obtained, assuming values of x adjacent spectra as one feature value. Further, L^{s}₁ₕ (h=1, 2, . . . , K) pieces of feature values are obtained by inputting each x number of spectra to each of the no-teacher machine learning ML^{s}₁ₕ and k pieces of non-teacher machine learning. After that, they are sent to each node N^{s}₁ₕ (h=1, 2, . . . , k, z=1, 2, . . . , w) of the input layer.

The learning value L^{s}₁ₕ (h=1, 2, . . . , K) of the sampling of the k nodes N^{z}₁₁ of the input layer calculated by the no-teacher machine learning ML^{s}₁ₕ is connected between the input layer and the hidden layer is sent to the input side of the no-teacher machine learning ML₂ₕ (h=1, 2, . . . , K). The criterion of judgment that the hidden layer, that is, the nerve layer outputs “1” or “0” can be calculated by using the registered speech recognition learning value and the cranial nerve trigger threshold (L 2 h, T 2 h) (h=1, 2, . . . , k). |LS 1 h−L 2 h|≤T 2 h−“1”, the hidden layer, that is, the nerve layer outputs “1” |L^{S}₁ₕ−L₂ₕ|≤T₂ₕ→‘1’ which means the hidden layer, that is, the nerve layer outputs ‘1’, otherwise it is |L^{S}₁ₕ−L₂ₕ|>T₂ₕ→‘0’ which means that there is no neural signal.

Likewise, the excitation level of the brain is determined based on the number of “1” output by the hidden layer, that is, the nerve layer. Based on the degree of excitement of the neural, that is, based on the number of “1” output by the hidden layer (nerve layer), the discriminated voice belongs to the V voice learned. This is not to say that it is the effect of brain decision making for speech recognition.

In the same way as above, at the time of identification, the probability that the output of each node of the hidden layer, that is, the nerve layer is “1” is calculated on the basis of the result of plural identification for the recognition of the voice to be identified and by automatically correcting the parameters of identification, it is possible to achieve the effect of self learning.

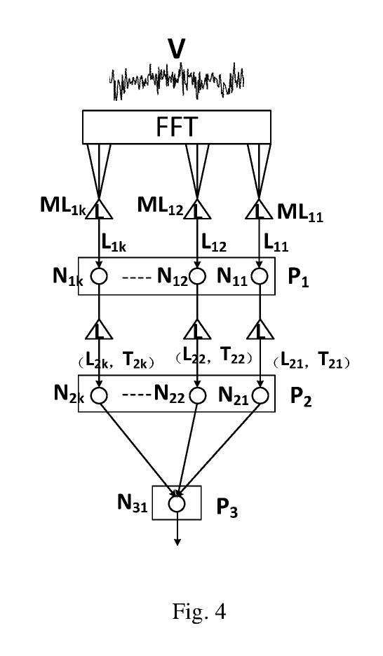

FIG. 4 is a schematic diagram of a model structure of super deep layer learning for speech recognition. As same as in FIG. 3, the model structure of super depth learning for actual speech recognition becomes as shown in FIG. 4. In the learning step of speech recognition, for the speech data V_{z} (z=1, 2, . . . , W) of w times, the data sₑ (e=1, 2, . . . , y) of the spectrum of the speech signal is transformed by fast Fourier transform FFT) can be converted. When the given data of adjacent x spectra are recognized as one spectral value, the feature values of k pieces of input layers are obtained, that is, k=y/x. Also, x spectra of the h^{th} feature information are inputted to each of the no-teacher machine learning ML¹₁ₕ and L^{z}₁ₕ (h=1, 2, . . . , K, z=1, 2, . . . , w) feature values are obtained. Ten, each value is sent to each node N₁ₕ (h=1, 2, . . . , k, z=1, 2, . . . , w) of the input layer.

The feature value L¹₁ₕ, L²₁ₕ, . . . , L^{w}₁ₕ, (h=1, 2, . . . , K) inputted to the k pieces of nodes N₁ₕ (h=1, 2, . . . , k) of the input layer and computed w times by the non-teacher machine learning ML₂ₕ (h=1, 2, . . . , k) are sent to the input side of the no-teacher machine learning ML₂ₕ (h=1, 2, . . . , k) connected as w times between the input layer and the hidden layer, that is, the neural layer. And then, k pieces of learning values L₂ₕ and threshold values T₂ₕ of k pieces of triggers of cranial nerves, that is, (L₂ₕ, T₂ₕ) (h=1, 2, . . . , k) can be calculated. The result is stored in a database as a learning value of speech recognition and a trigger threshold of a cranial nerve.

In the recognition step, the identified voice Vₛ is obtained by converting the spectrum data of the voice data Vₛ by the fast Fourier transform FFT in the same way as in the learning state described above. When the value of each x neighboring spectrum is assumed as one feature data, k=y/x pieces of input layer information is obtained. Further, x spectra of the h^{th} feature data are inputted to each of the no-teacher machine learning ML₁ₕ (h=1, 2, . . . , K) and L^{s}₁ₕ (h=1, 2, . . . , K) sampling values, and then sends them to each node N₁ₕ (h=1, 2, . . . , k).

The sampling feature value L^{s}₁ₕ (h=1, 2, . . . , K) of the k pieces of nodes N₁₁ of the input layer calculated by the no-teacher machine learning ML₁ₕ (h=1, 2, . . . , k) is connected between the input layer and the hidden layer, that is, the nerve layer and sent to the input side of the no teacher machine learning ML₂ₕ (h=1, 2, . . . , k), and the learning value of the registered speech recognition and the trigger threshold (L₂ₕ, T₂ₕ) (h=1, 2, . . . , K) of the cranial nerve is used to calculate criteria for judgment that the hidden layer, that is, the nerve layer outputs “1” or “0”. If |L^{S}₁ₕ−L₂ₕ|≤T₂ₕ→“1”, that is, the hidden layer (nerve layer) outputs “1”. Otherwise, |L^{S}₁ₕ−L₂ₕ|>T₂ₕ→“0”, that is, the hidden layer (nerve layer) outputs “0”.

Likewise, based on the degree of neural excitation which determines the excitation level of the brain based on the number of “1” output by the hidden layer, that is, the nerve layer, that is, the number of “1” outputted by the hidden layer, it represents the level of belongings to the learned voice V. This represents the effect of brain decision-making for speech recognition.

In order to improve the accuracy of speech recognition, the speech signal is divided according to the content of the speech signal and the state of pronunciation, and spectral analysis is performed on each of the divided speech information. In addition, the probability information of state transition is learned with the probability value of state transition among divided voice information as learning contents by using non-teacher machine learning. When performing speech recognition, it is possible to improve the accuracy of speech recognition according to a combination of several speech states, determine the speech content, and consider the probability of speech state transition.

Although the recognition image described above is to perform super depth learning processing, in addition to such a processing method, it is also possible to map images and sounds into a plurality of respective spaces and then t to process by the super depth learning method.

Next, a method of spatial mapping will be described. While conventional systems can be solved directly, problems of complex systems such as face recognition, image recognition and character recognition were often difficult to resolve directly in the usual way. One effective method that can deal with complex system problems is the theory of spatial mapping. The theory of spatial mapping is an idea which is included in the theory of artificial intelligence, and it responds to the problem of complex system by mapping the space of complex system into several simple spaces based on fuzzy mathematics. Although it can only solve the simpler problem, it is possible to solve the problem of a complex system by combining it from a plurality of spaces to a simple space and by solving a simple problem separately.

Here, one important point of the spatial mapping theory is that the method of mapping from the space of the complex system to the simple space decides the mapping model by thinking of the human brain. This method is called “human intervention”. Traditional mathematics originally is hard and difficult of intervening of human beings, but fuzzy mathematics is easy to use. In order to understand the objective function by humans, using membership functions of fuzzy mathematics formulated from several points of view, complex systems can be solved. Here, such an algorithm cannot be said to be within the scope of artificial intelligence because it can solve the problems of complex systems by creating fuzzy mathematical formulas based on human intervention.

The non-teacher machine learning using the artificial intelligence super depth learning model of the present invention will be described in detail as follows. The non-teacher machine learning is connected to each node corresponding to each other between the input layer and the hidden layer, that is, the neural layer of the new neural network self-organizing algorithm based on probability scale. Constructing such a new neural network can be said to be a revolutionary artificial intelligence model. Next, a self-organizing algorithm on non-teacher machine learning is introduced.

It is assumed that Gϵg_{f} (f=1, 2, . . . , ) is the set of the elements g₁, g₂, . . . , g_{ζ} with the probability distribution, that the central value of the set G is A (G), and also that the probability scale for the central value A (G) is M [G, A (G)]. It is assumed that the center value A(G⁽ⁿ⁻¹⁾) is the value of (n−1)^{th} calculation of iterative self organization calculation. Also, within the range of the probability scale M[G⁽ⁿ⁻¹⁾,A(G⁽ⁿ⁻¹⁾] for the central value A(G⁽ⁿ⁻¹⁾), a set G⁽ⁿ⁾ϵg_{f} (f=1, 2, . . . , k) of the included elements g₁, g₂, . . . , gₖ exists, and then, the self organization algorithm is as follows.

A⁽ⁿ⁾=A(G⁽ⁿ⁾)

M⁽ⁿ⁾=M[G⁽ⁿ⁾,A(G⁽ⁿ⁾)]

G⁽ⁿ⁾=G{A(G⁽ⁿ⁻¹⁾,M[G⁽ⁿ⁻¹⁾,A(G⁽ⁿ⁻¹⁾)]} (Equation 11)

According to the above equation 11, the center value and the probability scale finally calculated by repeating calculations can be said to be the estimation values closest to the base of the probability distribution from the elements g₁ [symbol] g₂, . . . , g_{ζ} which have the probability distribution. It can also be said to be a parameter of a probability distribution exceeding the accuracy of statistics. The center value calculated at the time of actual application is set as the feature value of one maximum probability with respect to the set Gϵg_{f} (f=1, 2, . . . , ζ) of the elements having the probability distribution. Further, the calculated probability scale is defined as a set G′ϵg_{f} (f=1, 2, . . . , ζ) of the new element that becomes the maximum probability distribution for the set Gϵg_{f} (f=1, 2, . . . , δ). Also, the calculated probability scale is taken as the trigger threshold of the cranial nerve. Because of these features, the super depth learning model submitted by the present invention can be said to be the model closest to the function of the brain.

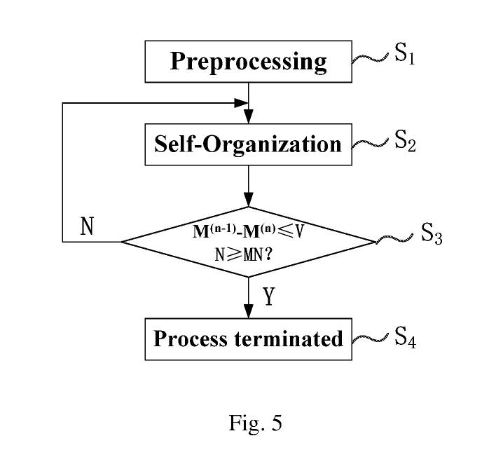

FIG. 5 is a processing flow diagram of self organization based on the probability scale. As shown in FIG. 5, if a set of elements g₁ [symbol] g₂, . . . , g_{ζ} having a given probability distribution is denoted by GΣg_{f} (f=1, 2, . . . , ζ), a self-organizing algorithm based on the probability scale have four steps as follows.

Step 1: It is a preprocessing step. M⁽⁰⁾ is set as the initial probability scale, A⁽⁰⁾ is set as the initial center value of the self-organization, V is set as the convergence value of the self-organization value, and MN is set as the maximum processing number of the self-organization. Also, n=0 is set to the initial value of the number of times of self organization processing.

There is no need to strictly set the method of determining the initial probability measure M⁽⁰⁾. It can be decided properly on a human level. For the value of the initial probability measure M⁽⁰⁾, at least part of the data needs to be included in the initialization probability measure M⁽⁰⁾ for the range of the final probability measure. The longer the initial probability measure M⁽⁰⁾ is, the longer the calculation time is. On the other hand, if the initial probability measure M⁽⁰⁾ is too small, it may be impossible to obtain a correct result.

In the method of setting the convergence value V, the accuracy of the processing result of the self organization decreases as the convergence value V increases. Conversely, the smaller the convergence value V is, the longer the calculation time is. The correct setting method is about 10% of the final self-organization probability scale. The setting method of the maximum number of times MN of self organization is generally sufficient by 5 to 10 times iteration.

Step 2: It is a self-organization step. When self-organization processing is performed n times, based on A⁽ⁿ⁾ as the self-organization central value and the probability scale M⁽ⁿ⁾ as a radius, a new central value V⁽ⁿ⁺¹⁾ and variance value S⁽ⁿ⁺¹⁾ are calculated for all the set elements g_{f} (f=1, 2, . . . , n). Also, V⁽ⁿ⁺¹⁾=A⁽ⁿ⁺¹⁾, S⁽ⁿ⁺¹)=M⁽ⁿ⁺¹⁾, and n=n+1 are set.

$$\begin{matrix}{V}^{( n + 1 )} = \frac{1}{ζ} {\sum }_{j = 1}^{ζ} {g}_{j} & ( Equation 12 ) \\ {S}^{( n + 1 )} = \frac{1}{ζ - 1} = {\sum }_{j = 1}^{ζ} {( {g}_{j} - {V}^{( n + 1 )} )}^{2} & ( Equation 13 )\end{matrix}$$

Step 3: Self-organization discrimination step. If (n≥MN) or self-organization processing convergence (|M₍ₙ₎−M⁽ⁿ⁺¹⁾|≤V), the next self-organization process is terminated and jumps to the self organization process end step 4. If they are not, it jumps back to step 2 to continue the self-organization process.

Step 4: Finishing self-organizing process. The probability measure M⁽ⁿ⁾ is a parameter of probability statistics having a plurality of attributes. For example, it is normal distribution, exponential distribution, Irral distribution, Weber distribution, triangular distribution, beta distribution and so on. For example, the probability measure M⁽ⁿ⁾ can be used as the variance value of the normal distribution.

The self-organizing algorithm of the probability scale can be widely applied in the field of artificial intelligence as one unmatched machine learning. In addition, a correlation analysis which is dramatically overcomes the basic constants of conventional statistics and closely related to basic constants, regression analysis and the like lead to breakthrough, and a new statistical algorithm is generated. Forming a new statistical relation theory by machine learning theory of artificial intelligence is anticipated.

With regard to the problem of scale in machine learning, why self-organizational algorithms can achieve transcendent transcendental results based on probability scale, the factor is to introduce probability scale and self-organization algorithm.

Next, the fuzzy event probability measure is described. Definition of Fuzzy Event Probability Measure: First, it is assumed that the function f (x) can be computed independently with a set of fuzzy spaces. When F (x) and p (x) satisfy the above fuzzy measure and probability measure condition, the fuzzy event probability scale M_{fp} is as follows.

M_{fp}=∫f(x)×p(x) (Equation 14)

The physical meaning of Equation 14 is stabilized by integrating many small fuzzy information and small probability information by solving the complexity problem by utilizing the properties of those measures It is possible to obtain valuable information value. By using the fuzzy event probability measure as a measure of self organization, it is possible to obtain an unexpected effect of solving the problem of the complex system.

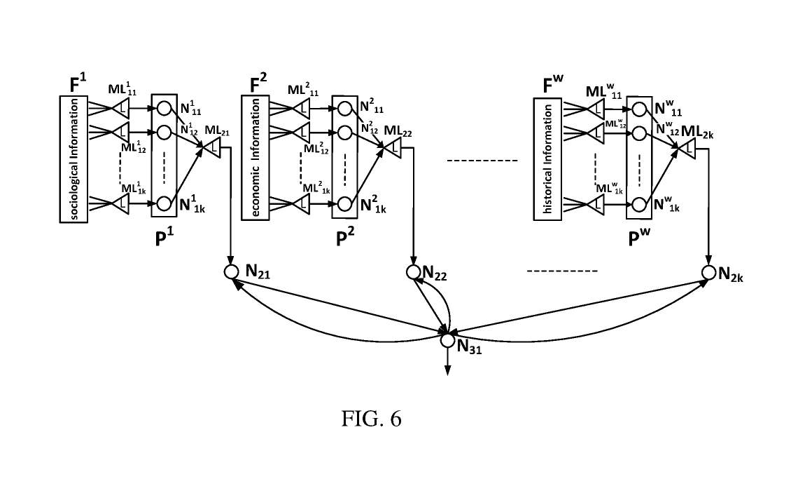

FIG. 6 is a schematic diagram of a stock forecasting platform introducing super depth learning. Here, the objective function is stock forecasting and objective function information is stock information. As shown in FIG. 6, in order to predict a stock from a plurality of angles, firstly let f¹ₙ (n=1, 2, . . . , y) be an element belonging to the sociological information F¹ related to prediction and obtain membership of fuzzy mathematics with human intervention is performed using a function, x pieces of data exist in each element fn, and when k=y/x, there are k pieces of input layer information. X pieces of data of the h^{th} input information are inputted to the non-teacher learning M¹₁ₕ (h=1, 2, . . . , K) and learned, and then, k pieces of learning values L¹₁₁, L¹₁₂, . . . , L¹₁ₖ related to sociology are obtained.

In the same way, let f²ₙ (n=1, 2, . . . , y) be an element belonging to the economic information F² related to the stock forecast, and for each x pieces of data, non-teacher learning M²₁ₕ (h= . . . , k) to learn, and obtain learning values L²₁₁, L²₁₂, . . . , L²₁ₖ related to k economics. Further, for each x pieces of data, an element belonging to historical information F^{w} related to prediction is f^{w}ₙ (n=1, 2, . . . , Y), after learning is performed to obtain learning values L^{w}₁₁, L^{w}₁₂, . . . , L^{w}₁ₖ related to k pieces of history. When learning is performed by w×h unmatched machine learning ML^{z}₁ₕ (h=1, 2, . . . , k, z=1, 2, . . . , w) as described above, w×h learning values L^{z}₁ₕ (H=1, 2, . . . , k, z=1, 2, . . . , w) is obtained. These data are sent to each node N^{z}₁ₕ (h=1, 2, . . . , k, z=1, 2, . . . , w) of P^{z} (z=1, 2, . . . , w).

For the learning data L¹₁ₕ L²₁ₕ, . . . , L^{w}₁ₕ (h=1, 2, . . . , W) inputted into each node N^{z}₁ₕ, L^{w}₁ₕ (h=1, 2, . . . , k), it is further learned using the no-teacher machine learning ML₂₁, ML₂₂, . . . , ML₂ₖ, k pieces of learning values L₂₁, L₂₂, . . . , L₂ₖ, and threshold values T₂₁, T₂₂, . . . , T₂ₖ of k pieces of cranial nerve triggers are obtained. Each learning value is defined to be the predicted value generated by the related information of the corresponding stock forecast. In order to make final decision, the predicted value and trigger threshold of the cranial nerve are sent to the output layer, that is, the cerebral cortex through each node of the hidden layer, that is, the nerve layer. In the output layer, that is, the cerebral cortex, the prediction range is calculated by the predicted values L₂₁, L₂₂, . . . , L₂ₖ of all the related information, and the self test is performed in this prediction range.

In the self-testing method, the output layer, that is, the cerebral cortex, gives a self-test value TVᵢ (i=1, 2, . . . , r), where r is the number of self-tests. TVᵢ is sent to each node of the hidden layer, that is, nerve layer.

When computing |TVᵢ−L_{2z}| (i=1, 2, . . . , r, Z=1, 2, . . . , w) on each node of the hidden layer, that is, the neural layer, based on the degree of excitation of the hidden layer, that is, the nerve layer, the output layer, that is, the cerebral cortex layer finds the maximum excitation self-test value. This self-test value is outputted as the final predicted value.

If the prediction fails, the output layer, that is, the cerebral cortex, can use the actual stock data to evaluate the various factors set by the fuzzy parameters. Fuzzy parameters can be automatically or manually adjusted to achieve the highest accuracy of predictive effects.

The method of stock forecasting for artificial intelligence super depth learning is a method in which all features related to prediction or mathematical prediction model calculation results are obtained by processing of unmatched teacher machine learning, and sending to each node of the input layer of super depth learning. Further, information from each node of the input layer, a predicted value and a trigger threshold of the cranial nerve are calculated by the unmatched teacher machine learning and sent to the output layer, that is, the cerebral cortex layer. The output layer, that is, the cerebral cortex layer generates a prediction range according to the predicted value and selects a self-test value. It also sends to each node of the hidden layer, that is, the nerve layer. Based on the degree of excitement of the hidden layer, that is, the nerve layer, the output layer, that is, the cerebral cortex, finds the maximum excitation self-test value. This self-test value is outputted as the final predicted value.

The artificial intelligence super depth learning model can apply visual recognition and speech recognition with high accuracy to industrial robots. In particular, since the non-teacher machine learning model can construct a distributed machine learning system, for each part of the system such as industrial machine tool, automobile driving, etc., a plurality of non-teacher machine learning of mixing is possible, and can evolve dramatically in comparison with conventional deep learning.

The artificial intelligence super depth learning model can be stored as executable code in a memory device, and the executable code can be used for causing a processor of a device, mobile terminal, or a computer to perform the processes described above.

In embodiments of the present disclosure, the processor executes each processing stage of the embodiments according to the program stored in the memory device. The computer may be one apparatus or a system in which a plurality of processing apparatuses is connected through the network.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for constructing an artificial intelligence super depth learning model, comprising:
inputting by an objective function to input into each node of an input layer by interposing a no-teacher machine learning;
connecting the no-teacher machine learning mutually between each node of the input layer and a nerve layer;
calculating the output reference value, wherein the output reference value is at least one learning result obtained from no-teacher machine learning, including learning values, brain neural triggering thresholds, or sampling values; and
determining an excitation level according to output reference values of all the nerve layers.

2. The method of claim 1, wherein the no-teacher machine learning is characterized by a self-organization algorithm for obtaining a probability scale, a fuzzy event probability measure, or a center value by repeated processing on a basis of a probability scale or a fuzzy event probability measure.

3. The method of claim 2, wherein data belonging to a probability distribution of the probability scale has a scale, which is a value that measures a maximum probability distribution among the data.

4. The method of claim 2, wherein in probability information and data belonging to ambiguous information, the fuzzy event probability measure has a scale which is a value that measures a maximum fuzzy event probability measure among the data.

5. The method of claim 4, wherein the probability scale or the fuzzy event probability measure is a threshold of the trigger values of the brain neural.

6. A device of an artificial intelligence super depth learning model, comprising a memory containing executable code having stored thereon instructions, and a processor coupled to the memory configures to execute the executable code to:
extract feature information on a feature value of an objective function information from input information by non-teacher machine learning and input the feature information to an input layer;
obtain a feature value of an input data, a probability scale, or a fuzzy event probability measure through the no-teacher machine learning connected between each node of the input layer and a nerve layer, the learning data of the probability scale or the fuzzy event probability measure are logged and used as a trigger threshold of a cranial nerve;
a calculated output reference value is at least one learning result obtained from no-teacher machine learning, including learning values, brain neural triggering thresholds, or sampling values; and
determine the degree of excitation of the brain and determine the final result by a number of neural signals triggered from the nerve layer.

7. A general purpose mobile terminal equipment equipped with an artificial intelligence super deep layer learning model, comprising a memory containing executable code having stored thereon instructions, and a processor coupled to the memory configures to execute the executable code to:
mutually connect with a teacher machine learning between the input information and each node of an input layer, and between each node of the input layer and a nerve layer; and
process a self-organization algorithm based on a probability scale or a fuzzy event probability measure.

8. A software program of an artificial intelligence super deep layer learning model characterized by generating an algorithm comprising;
mutually connecting with the teacher machine learning respectively between the input information and each node of an input layer, and between each node of the input layer and a hidden layer, the hidden layer being a nerve layer; and
processing a self-organization algorithm based on a probability scale or a fuzzy event probability measure.
